(19) United States
(12) Patent Application Publication
(10) Pub. No.: US 2003/0227644 A1
(43) Pub. Date: Dec. 11, 2003

(54) Methods and systems for driver independent customized printing

(75) Inventor: Andrew Rodney Ferlitsch, Tigard, OR (US)

Correspondence Address: Scott C. Krieger, Patent Counsel, Sharp Laboratories of America Inc., 5750 NW Pacific Rim Boulevard, Camas, WA, 98607, US

(73) Assignee: Sharp Laboratories of America, Inc.

(21) Appl. No.: 10/404,789

(22) Filed: Mar. 31, 2003

Related U.S. Application Data
(63) Continuation-in-part of application No. 09/681,208, filed on Feb. 22, 2001.
(60) Provisional application No. 60/261,132, filed on Jan. 11, 2001.

(51) Int. Cl. G06F 15/00; G06F 3/12; G06F 13/00

(52) U.S. Cl. 358/1.13; 358/1.15

(57) ABSTRACT

Embodiments of the present invention comprise systems and methods for modification of print stream data without print driver modification or interference.

### RELATED REFERENCES

This application is a continuation-in-part of U.S. patent application Ser. No. 09/681,208, entitled “Methods and Systems for Print-Processor Modified Printing” filed Feb. 22, 2001 by inventors Ferlitsch et al. which claims the benefit of Provisional Application Serial No. 60/261,132, entitled “Methods and Systems for Print-Processor Modified Printing” filed Jan. 11, 2001 by inventors Ferlitsch et al.

### BACKGROUND

Many computing device platforms and printing systems are available today and embodiments of the present invention may be implemented with many of these systems, however, due to the prevalence of the Microsoft Windows® operating system family, embodiments used in conjunction with Windows® systems will be used to illustrate its functions. Accordingly, details of Microsoft Windows® printing processes will be explained.

Microsoft Windows® operating systems typically employ two file types in the printing process. These file types are Enhanced Metafile (EMF) and raw format (raw) files.

Raw format files are device dependent files that are destined and formatted for a specific device. An example of a raw file is an encapsulated Postscript file, which is formatted to be interpreted by a Postscript printer. EMF files are device independent files that contain graphic device interface (GDI) function calls that reproduce an application's graphic objects on a printer. EMF files are used to quickly record a printed document and return system control to a user. After control is returned to the user, the function calls stored in the EMF file may be executed and sent to the printer in the background.

Files may be recorded for later play back by using a spool file that is written and later de-spooled to a printing device. Spool files may be used for EMF and raw files. However, a print job may also be written directly to a printing device without using a spool file. Some typical printing process scenarios using raw spool files and EMF spool files are described below to introduce the elements and relationships of these processes and how they relate to embodiments of the present invention. These scenarios are derived from information contained in the Microsoft Windows 95® Driver Development Kit (DDK) documentation, the Microsoft Windows 2000® DDK documentation and the Microsoft Windows NT® DDK documentation, incorporated herein by reference.

A typical printing process scenario using a raw spool file may be described in reference to FIG. 1 wherein an application 10 initiates a print request 1 by calling a graphic device interface (GDI) 12. Application 10 may be a word processor, spreadsheet, browser, database program or some other program that runs on the underlying operating system. Typically, application 10 will create a device context (DC) and draw an object (i.e., a circle, a line, etc.) to the DC. The application 10 will then call the GDI with a print request directed to a particular printer 16 (FIG. 2) using that DC.

The GDI 12 will call the printer driver 14 associated with the particular printer 16 and request 2 instructions on how to render the object on that particular printer 16. The printer driver 14 will return 3 the instructions on how to render the object on the printer 16. In Windows 95®, used in this printing process example, the printer driver 14 is written in 16-bit code and communicates with a 16-bit GDI 12. This GDI will then pass the print request to a 32-bit GDI (GDI32) 18 to handle the 32-bit Windows 95® (spooler process. GDI32 makes an inter-process call 5 to the spooler process 20.

Spooler process 20 calls 6 the router 22 to route the print job to printer 16. In this example, illustrated in FIGS. 1-2, the router 22 sends the print job to a local print provider 24. In other scenarios, the router 22 may send print jobs to a network printer through a network print provider (not shown). When the default Windows 95® spooler is used, network print jobs are spooled and de-spooled on the client machine just as local print jobs. The network print server is contacted only during despooling. Windows NT/2000® client machines handle print jobs to network print servers differently, these machines use remote procedure calls (RPCs) to call the necessary printing application program interfaces (APIs) on the print server. In these NT/2000 scenarios, the print jobs do not show up on the local spooler queue, the print spooler on the print server handles spooling and de-spooling. This RPC method can be used in conjunction with Windows 95® spoolers also. Print jobs to locally connected printers or locally queued to (LPR) to network printers are handled similarly to Windows 95, 98 local print jobs.

In this local printing scenario, the router 22 calls the local print provider 24 with the print job. Local print provider 24 writes or “spools” 8 a raw spool file 26 to disk for later access. This is done to avoid waiting for the printer to complete the job before control is returned to the application. These steps from initiating the print request 1 to writing to spool file 26 may be repeated many times. Data may be appended to spool file 26 until an application signals that the print job is complete. This may be signaled with an EndDoc function. Local print provider 24 also starts 9 a background thread 28 that will determine the best time to start playing back or “despooling” the spool file 26 to the printer 16.

In reference to FIG. 2, Thread 28 monitors spooler subsystem resources to determine a good time to playback spool file 26. When thread 28 determines that playback should commence, a StartDoc function call 17 is sent to print processor 32 to start a new print processor thread 11. Print processor thread 11 invokes the local print provider 24 with a ReadPrinter function call to read part of the spool file 26. A print processor thread 19 also uses the local print provider 24 to invoke the language monitor 34 with a WritePrinter function call to send data through the physical port 38 connected with the bi-directional printer 16 specified previously.

For raw spool files, the default print processor 32 simply passes data through without changing or interpreting any of the information. A language monitor 34 is used in this example because the destination printer 16 is a bi-directional printer. When non-bi-directional printers are used a port monitor 36 would be invoked instead of the language monitor 34. A language monitor 34 and port monitor 36 may be separate components or may be integrated into one monitor.

Language monitor 34 calls 13 a port monitor 36 to send print job data to the printer 16. The port monitor 36 then sends 15 the raw data through the physical port 38 to the printer 16. This process of reading from a spool file 26 and forwarding data to the printer 16 may be repeated several times to complete a print job. This is typically repeated until an end-of-file is reached or the job is cancelled. The playback thread 19 is terminated at that point. The combination of spooler process, router, local print provider, print processor, language monitor and port monitor may be referred to collectively as a “spooler” 30.

When Windows Enhanced Metafile (EMF) format files are used in the printing process of Windows 9.x systems, process components interact differently than with raw files. An example printing process, shown in FIGS. 3 and 4 illustrates the printing process using EMF files.

This process typically commences when an application 40 creates a printer DC and draws an object to the DC (not shown). The application 40 then calls 41 GDI 50 with an EMF spooling request for a designated printer 68. GDI 50 queries 42 the printer driver 52 associated with the designated printer 68 to determine whether the driver 52 supports EMF spooling. If the driver 52 supports EMF spooling, GDI 50 changes the printer DC to an EMF DC and writes 43 the instructions for rendering the object to the EMF DC 54 (creates EMF files). GDI 50 then passes 44 the print request to the 32-bit GDI (GDI32) 56 because, in this example the Windows 95® spooler process is 32-bit code. GDI 32 subsequently makes an inter-process call 45 to the spooler subsystem 70 with a description of the print job.

The spooler process 58 (SPOOL32.EXE), in the spooler system 70, calls the router 60 to pass the print job description to the print provider 62 that can reach the designated printer 68. In this example, a local print provider 62 is used, but a network print provider may also be used. When the default Windows 95® spooler is used, network print jobs are spooled and de-spooled on the client machine just as local print jobs. The network print server is contacted only during despooling. Windows NT/2000® client machines handle print jobs to network print servers differently, these machines use remote procedure calls (RPCs) to call the necessary printing application program interfaces (APIs) on the print server. In these NT/2000 scenarios, the print jobs do not show up on the local spooler queue, spooling and despooling are handled by the print spooler on the print server. This RPC method can be used in conjunction with Windows 95® spoolers also.

When the router 60 has called the print provider 62, the local print provider 62 creates 48 a job description file 64 and adds 48 a record to the job description file 64 each time it is called for the job until all the EMF page files have been spooled and each EMF file name and location is recorded in the job description file 64. When information about the last EMF file in the print job has been recorded, the local print provider 62 will call the spooler process 58 with an EndDoc function call. This signals the spooler process 58 that the complete job is spooled and ready for despooling. For multi-page jobs, these steps from initial spooling request 41 to job description file recording 48 are repeated for each page of a job.

When EMF file spooling is complete, the spooler process 58 sets a ReadyToPrint attribute on the print job and initiates an event 49 that signals to the port thread 66 that a job is available for printing. Port thread 66 responds to this event by determining the best time to start the despooling process and, at that time, loads 81 the print processor 72, as shown in FIG. 4. The print processor 72 will determine that the file format is EMF and call GDI32 56 with a Windows 95® function call 82.

GDI32 then invokes a gdiPlaySpoolStream function to read 83 from the job description file 64 that provides a fully qualified path to an EMF spool file 54. Through the job description file 64 that comprises a list of path names to EMF files, GDI32 knows about all the pages in the print job. The GDI32 gdiPlaySpoolStream function also calls GDI 50, using a thunk built into GDI32, with the path to the EMF spool file to render the page. GDI 50 only knows about one page in the print job at a time.

GDI 50 calls the printer driver 52 associated with the designated printer 68 chosen in application 40 and obtains a DC for the printer 68. GDI 50 then reads page-rendering instructions from the spooled EMF file 54 and passes 85 them one at a time to the printer driver 52 which uses as many instructions as are necessary to render the first part of the page. When the 16-bit printer driver 52 renders a part of the page, it passes 87 the printer-specific raw page data back to the GDI 50 which, in turn, passes 88 the raw data to GDI32 56. GDI32 56 then passes 89 the raw data to the spooler process 58 which then follows the same procedures it would for a raw format files as explained above.

Spooler process 58 calls 90 the router 60 to route the print job to printer 68. In this example, illustrated in FIGS. 3 and 4, the router 60 sends the print job to a local print provider 62. In other scenarios, the router 60 may send print jobs to a network printer through a network print provider (not shown). In this local printing scenario, the router 60 calls the local print provider 62 with the print job. Local print provider 62 invokes the language monitor 74 with a WritePrinter function call to send data through the physical port 78 connected with the bidirectional printer 68 specified previously.

A language monitor 74 is used in this example because the destination printer 68 is a bi-directional printer. When non-bi-directional printers are used a port monitor 76 would be invoked instead of the language monitor 74. A language monitor 74 and port monitor 76 may be separate components or may be integrated into one monitor. Language monitor 74 calls 93 a port monitor 76 to send print job data to the printer 68. The port monitor 76 then sends 94 the raw data through the physical port 78 to the printer 68.

Parts of EMF pages are processed in this manner and printed until an entire page is printed. GDI32 56 then gets the path to the EMF spool file for the next page and calls GDI 50 to use the instructions in that EMF file to render the next page of the print job. The print job is finished when all the paths to EMF spool files are used up.

Other versions of the Microsoft Windows operating systems, such as Windows NT and 2000 may use different printing processes as described with reference to FIG. 5. These processes may be used to print data to local, network and remote printers either directly or through a network print server. EMF data may also be processed differently. For example, in Windows NT and 2000, the entire EMF data for all pages is passed to GdiPlayEMF( ) in one pass, rather than one page at a time. If the EMF data is to be queued on a print server, the EMF data may be passed directly to the print server without rendering on the client. A mirror copy of the driver on the server renders the EMF data instead.

Typically, a user will employ an application 100 to create a print job by calling GDI 102 functions. The GDI 102 and/or application 100 will then call Winspool.drv 104, which is a client interface into the spooler. This client interface, Winspool.drv 104, exports the functions that make up the spooler's Win32® API and provides RPC stubs for accessing the server. The print job is then forwarded to the spooler's API server, Spoolsv.exe 106 that can be implemented as a Windows 2000 service that is started when the operating system is started. This API server module exports an RPC interface to the server side of the spooler's Win32® API. This module implements some API functions, but most function calls are passed to a print provider by means of the router, spoolss.dll 108.

The router 108 determines which print provider to call, based on a printer name or handle supplied with each function call, and passes the function call to the correct provider 110, 112 or 114. If the selected printer is managed by the client system, the local print provider, localspl.dll 110, handles the print job. Printers managed by the local print provider 110 do not have to be physically local to the client, they may also be directly connected to network cards without using a server. When these printers are used, the print job is passed to the kernel-mode port driver stack 116 and on to the printer 118.

When printers located on a Windows NT/Windows 2000 server are selected, the router 108 directs the print job to the network print provider, Win32spl.dll 112. This network provider uses RPC to redirect calls from the client's router to the network server's spoolsv.exe process 124, which forwards the print job to the network server's router 126. Because the network printer is local to the print server system, the network server router 126 routes the job to the server's local print provider 128. The job is then directed to the server's kernel-mode port driver stack 130 and out to the selected network printer 132.

Remote printers may also be used with these systems. When a remote printer is selected, the client router 108 may direct the print job to the local print provider 110 which will forward the job to the kernel-mode port driver stack 116 and on to the remote printer 142 using a network protocol. When the local print provider 110 accesses a remote printer 142, the provider 110 uses a port monitor that can use network protocols recognized by the remote printer or its server.

Printers managed by non-Windows NT/2000 servers (e.g., Novell servers) may also be accessed through this print system. This may be achieved by using a local print provider 110 that directs the print job to the kernel-mode port driver stack 116 and on to the printer's server 136 using a type of network protocol. The server 136 then directs the job to the destination printer 140. This may also be achieved using a customized print provider 114 which sends the job to the kernel-mode port driver stack 116 which uses a network protocol to send the job on the printer's server 134 which then directs the job to the destination printer 138.

An example of these printing processes may be explained with reference to FIG. 6, which illustrates a Windows 2000 print process. In this process, an application 150 is used to create a print job with the Graphics Device Interface (GDI) 152. When the print job's initial output file is in raw format 154, the printer driver's printer graphics DLL 156 works in conjunction with the GDI 152 to create a print job that is sent to the client interface 160 of the spooler 190. Client interface 160 sends the job to the API server 162 which forwards the job to the router 164. In this example, the router 164, sends the job to the local print provider 165 as it is a local print job.

Within the local print provider 165, a print job creation API 168 is invoked. This API 168 accesses the printer driver's printer interface DLL 174 and creates a job spool file 176. The job creation API 168 also forwards job information to the job scheduling API 170 which initiates a job scheduler thread 172.

At this point, the file format is checked 178 within print processor 192. If the initial job file is in a raw format already, the job is sent to the language monitor DLL 182 and on to the port monitor 184 which sends the job to the kernel-mode port driver stack 186. Port driver stack 186 sends the job to the selected printer 188 for final printing.

When an application 150 creates a print job with GDI 152 in EMF format, the job is sent 154 to a client spooler interface 160. Client interface 160 sends the job to the API server 162 which forwards the job to the router 164. Again, in this example, the router 164, sends the job to the local print provider 165 because the print job is local.

Within the local print provider 165, a print job creation API 168 is invoked. This API 168 accesses the printer driver's printer interface DLL 174 and creates a job spool file 176. The job creation API 168 also forwards job information to the job scheduling API 170, which initiates a job scheduler thread 172.

At this point, the file format is checked 178 within print processor 192. If the initial job file is in EMF format, the job is sent to the print processor DLL 180 which directs the job back to GDI 152 for conversion to raw format with the help of printer interface DLL 174. The converted job is then sent back through the spooler client interface 160, API server 162 and router 164 to the print provider 165. In the local print provider, the job is processed by the print job creation API 168, job scheduling API 170 and job scheduler thread 172. Because the job is now in raw format, the job is sent to the language monitor DLL 182 and on to the port monitor DLL 184 and kernel-mode port driver stack 186 before arriving at the destination printer 188.

### SUMMARY

Embodiments of the present invention comprise methods and systems for modification of print stream data to support printing device features that are not supported by the existing printer driver or to otherwise modify print stream data without modification of the printer driver.

### BRIEF DESCRIPTION OF THE DRAWINGS

In order that the manner in which the above-recited and other advantages and objects of the invention are obtained, a more particular description of the invention briefly described above will be rendered by reference to specific embodiments thereof which are illustrated in the appended drawings. Understanding that these drawings depict only typical embodiments of the invention and are not therefore to be considered to be limiting of its scope, the invention will be described and explained with additional specificity and detail through the use of the accompanying drawings in which:

FIG. 1 is a diagram depicting a typical prior art printing process using a raw spool file;

FIG. 2 is a diagram depicting a continuation of the typical prior art printing process using a raw spool file shown in FIG. 1;

FIG. 3 is a diagram depicting a prior art printing process wherein EMF files are spooled;

FIG. 4 is a diagram depicting a continuation of the typical prior art printing process wherein EMF files are de-spooled;

FIG. 5 is a diagram depicting a prior art printing process used in a Microsoft Windows NT/2000 operating system;

FIG. 6 is a diagram depicting the prior art printing process used in a Microsoft Windows NT/2000 operating system shown in FIG. 5;

FIG. 7 is a diagram depicting an embodiment of the present invention comprising a supplemental print user interface;

FIG. 8 is a diagram depicting an embodiment of the present invention comprising a spooler that performs print job modification functions;

FIG. 9 is a diagram depicting an embodiment of the present invention comprising a print processor that performs print job modification functions;

FIG. 10 is a diagram depicting an embodiment of the present invention comprising a supplemental print application;

FIG. 11 is a diagram depicting an embodiment of the present invention comprising a print processor that performs print job modification functions;

FIG. 12 is a diagram depicting an embodiment of the present invention comprising server-based print job modification components; and

FIG. 13 is a diagram depicting an embodiment of the present invention comprising server-based print job modification components and a supplemental printing application.

### DETAILED DESCRIPTION

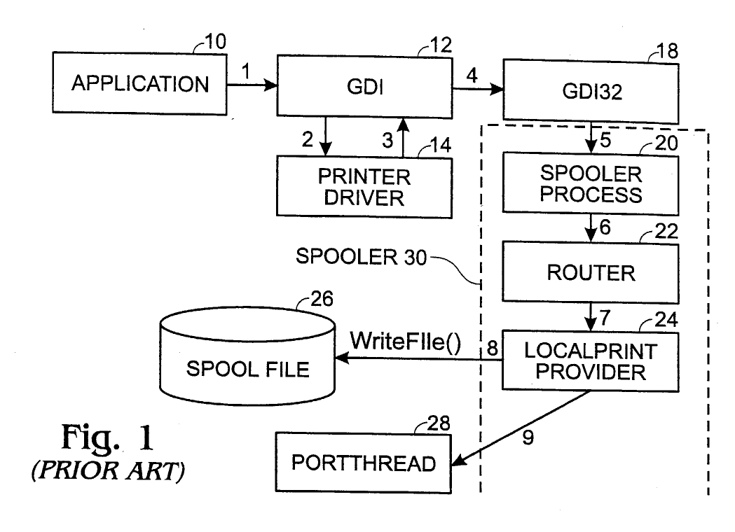

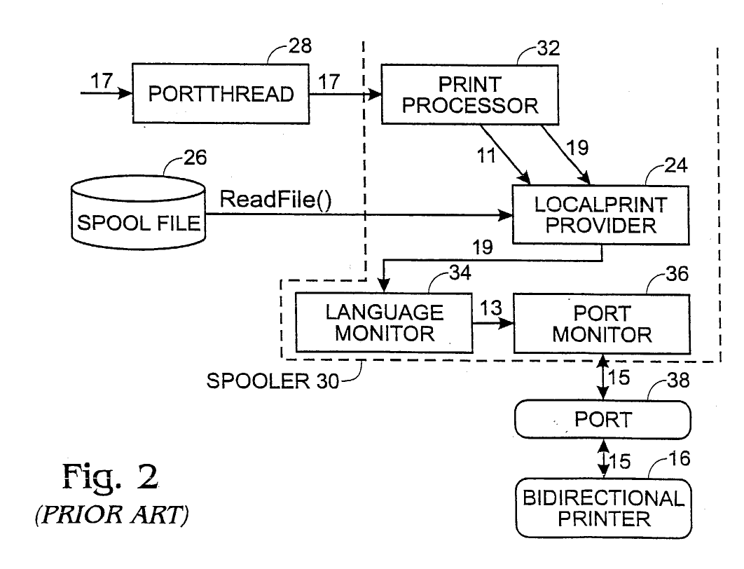

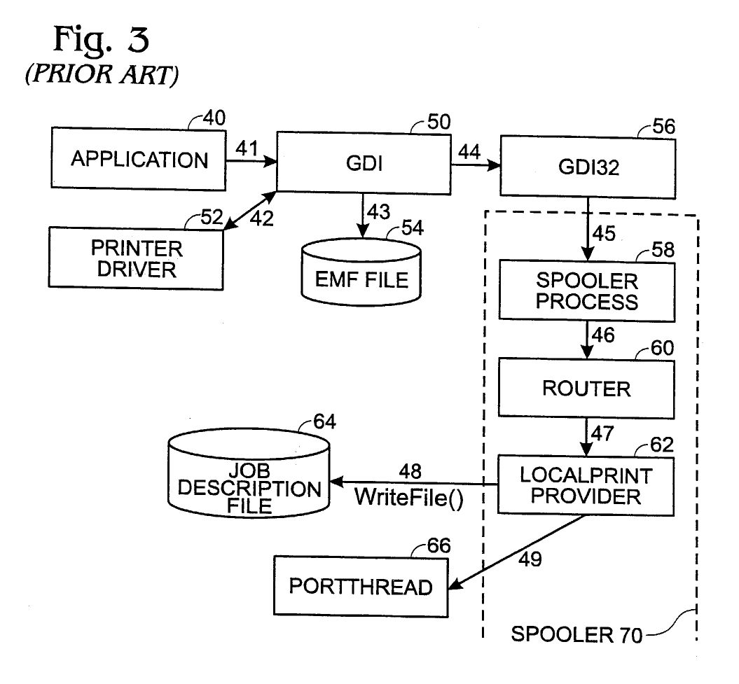

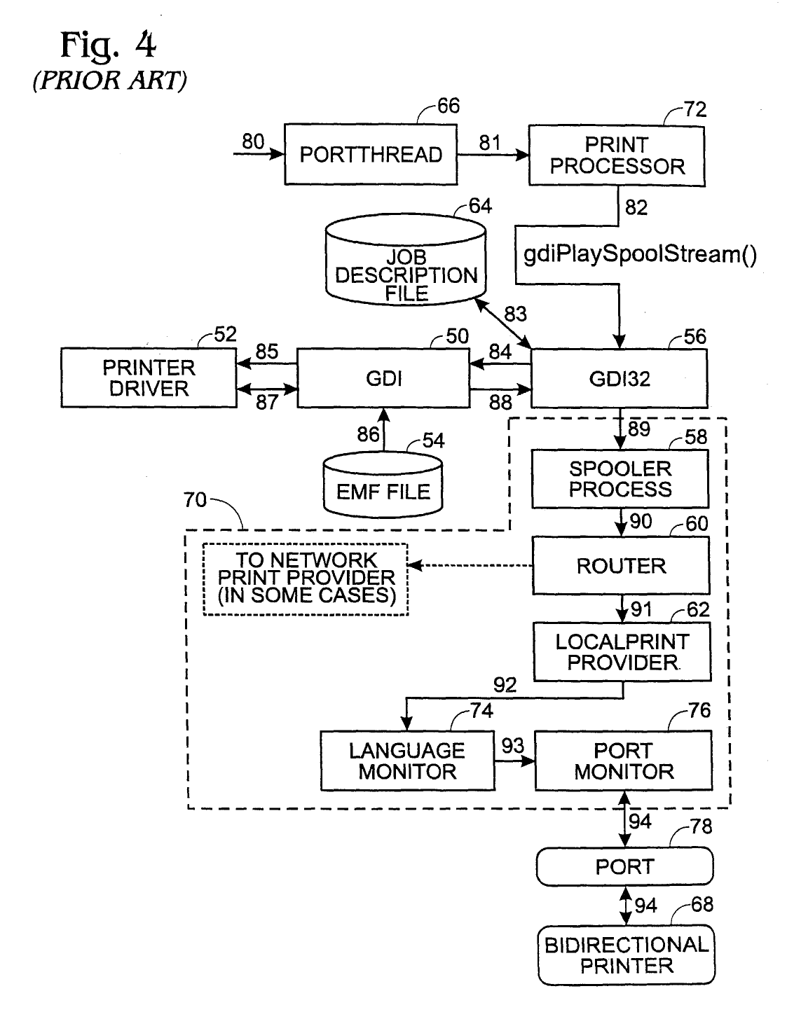

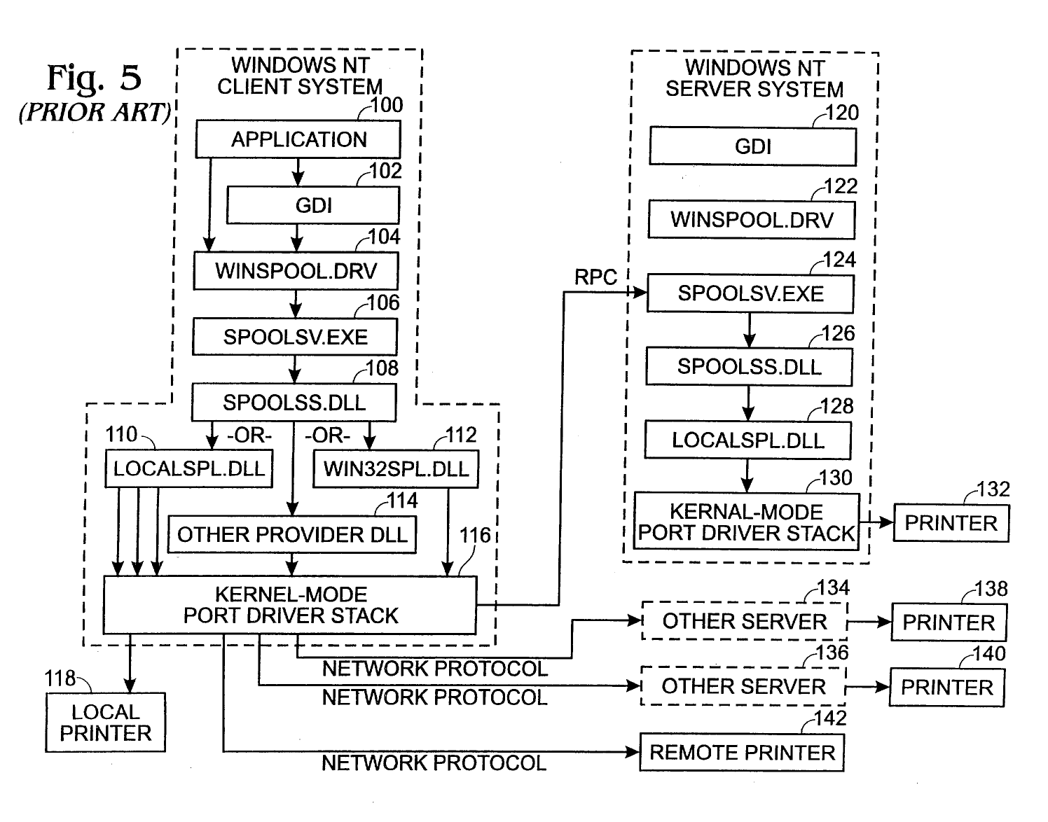

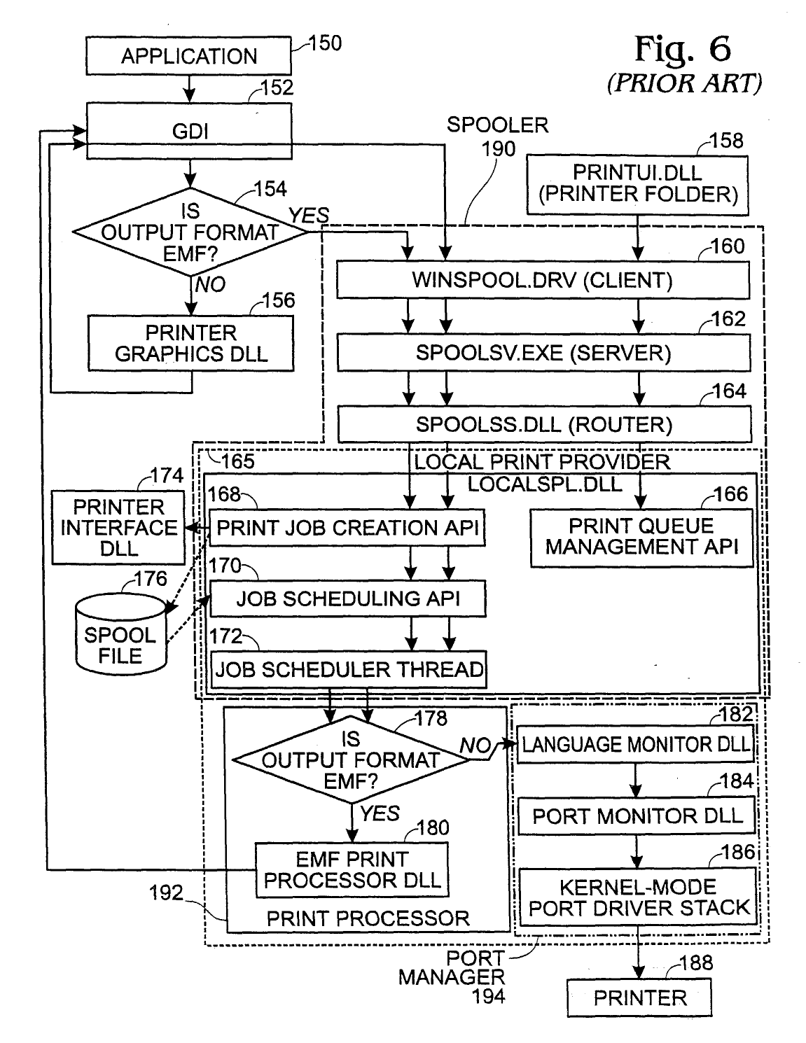

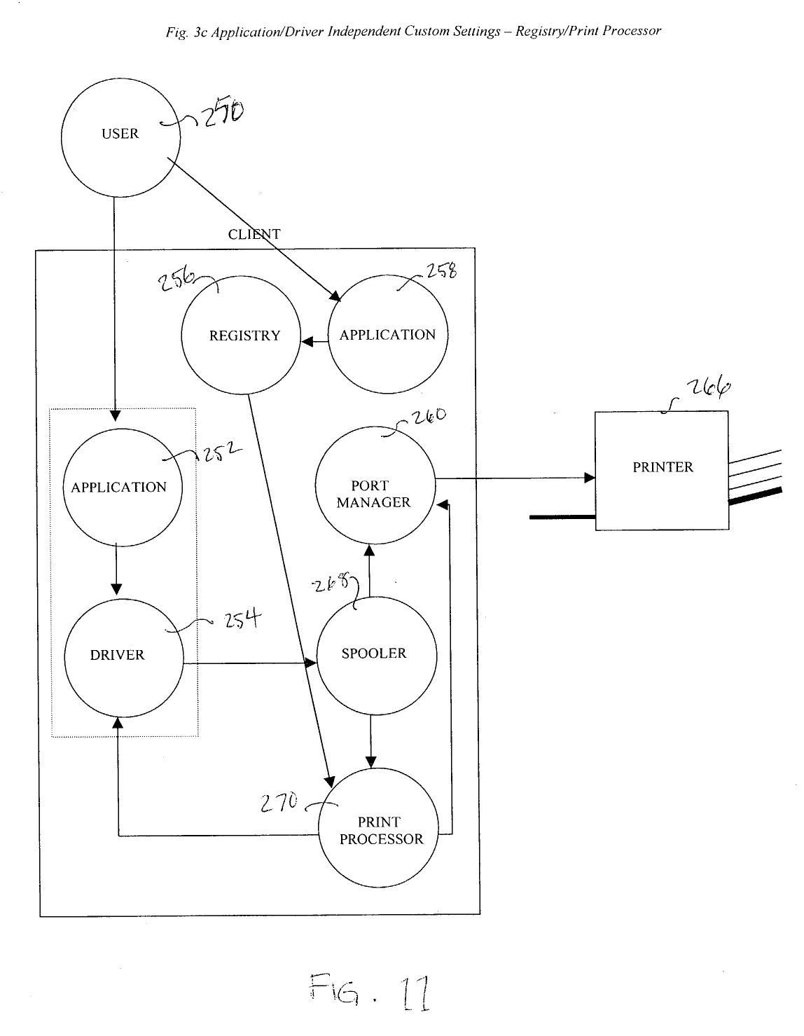

The figures listed above are expressly incorporated as part of this detailed description. It will be readily understood that the components of the present invention, as generally described and illustrated in the figures herein, could be arranged and designed in a wide variety of different configurations. Thus, the following more detailed description of the embodiments of the systems and methods of the present invention, as represented in FIGS. 1 through 13 is not intended to limit the scope of the invention, as claimed, but is merely representative of the presently preferred embodiments of the invention. Some embodiments of the present invention will be best understood by reference to the drawings, wherein like parts are designated by like numerals throughout.

To simplify discussion of a printing system some groups of system components may be referred to collectively. A group of components comprising a spooler client interface 160, spooler API server 162, router 164, print job creation API 168 and job scheduling API may be referred to as a spooler 190 in a Windows NT/2000 operating system. A group of components comprising a language monitor 182, port monitor 184 and port driver stack 186 may be referred to as a port manager 194. A group of components comprising a file format director 178 and EMF print processor DLL 180 may be referred to as a print processor 192. Equivalent component groups may be referred to by these terms also whether in a Microsoft operating system or another system.

The systems and methods of embodiments of the present invention typically operate within a system comprising one or more printers connected together in a common network environment (locally connected, remotely connected through network print queue or combinations thereof), a computing device capable of spooling a print job, and a printer driver and print processor compatible with the printing devices, such as in the Microsoft Windows 9x, NT, 2000 and XP operating systems.

Embodiments of the present invention which utilize a Microsoft Windows® operating system generally comprise a printer driver, spooler, print processor and other print system components which process print tasks generated through the operating system and applications running on the operating system. Embodiments used in conjunction with other operating systems will utilize similar processing elements.

Exemplary embodiments of the present invention will be described with terminology related to a Microsoft Windows® environment, however these terms shall relate to equivalent elements in other operating systems. For example, the print processor described in many embodiments will relate to a print processor common in the Windows® environment as well as elements with equivalent functions in other operating systems.

The definitions in this and subsequent paragraphs apply throughout this specification and related claims. The term “print job” may refer to any combination of data that can be printed. A fax transmission may be one form of print job. A print job may comprise text and/or graphics and may comprise part of a page, a single page or many pages. Print jobs may be rendered or un-rendered. Generally, a print job is generated by an application, such as a word processor, spread sheet, etc., however, a print job may also comprise a file or data in memory that may be sent directly to a print process.

The term “print copy” or “copy” may refer to data, code or commands which generate a single printing device output of a print job or may refer to the actual hard copy output of the print job.

The term “print task” may comprise any combination of print jobs and copies thereof. A print task may comprise one or more print jobs and one or more copies of each print job.

The term “network” may refer to any combination of computing devices and peripherals, such as printing devices, wherein the devices can communicate with each other. The term “network” may comprise Local Area Networks (LANs), Wide Area Networks (WANs) and many other network types. A network may be connected using conventional conductive cable, fiber-optic cable, phone line cable, power line cable or other electrical and light conductors and other signal transmission media as well as wireless connections using infrared, RF or other wireless methods

References to a Microsoft Windows or Windows operating system may refer to any version or variation of a Microsoft Windows operating system comprising Windows 95, Windows 98, Windows NT, Windows 2000, Windows ME, Windows XP and others. While exemplary embodiments of the present invention may be directed to a Windows operating system and environment, systems and methods directed to other operating systems such as Macintosh, UNIX, DOS, Linux, MVS and others are to be contemplated within the scope of the present invention.

Embodiments of the present invention may be embodied in software, firmware, hardware and other forms that achieve the function described herein. As embodiments of the present invention may be adapted to many environments with varying computing devices, operating systems, printing devices, network hardware and software, applications and other variables, these embodiments may take many forms to achieve their function. Some embodiments may also be transmitted as signals, for example, and not by way of limitation, embodiments may be transmitted as analog or digital electrical signals or as light in a fiber-optic line. All of these embodiments are to be considered within the scope of the present invention.

Some embodiments of the present invention may provide support for advanced print features on legacy or traditional systems without modification of existing printer drivers and applications. Some legacy systems have printer drivers built into the application. Without driver replacement or modification, these printer drivers are only able to support features and Page Description Languages (PDLs) that existed at the time the application was developed. This arrangement places limitations on the ability to use newer printing devices with richer features.

These limitations make it difficult to adapt state-of-the-art printers to legacy markets. Advanced features include, but are not limited to, sheet assembly features like N-up, Booklet and others and finishing options such as stapling, saddle stitch and others. Typically, these features are enabled through a printer driver, however these legacy systems with their antiquated “hard-wired” drivers do not allow these capabilities.

Other traditional systems including some Windows and Apple Macintosh systems may use printer drivers that are decoupled from their applications. These drivers may be updated for newer devices, however, if they do not represent a significant market segment, driver modification may not be feasible.

Embodiments of the present invention provide methods and systems that may enable advanced device features independent of the existing printer driver, the application or the operating system.

Embodiments of the present invention may comprise computer systems or networks with at least one printing device and at least one computing device. Some embodiments may further comprise other system or network components servers, routers, hubs and other devices. In these systems, at least one computing device will be capable of initiating a print job and sending the print job to various print stream components such as a spooler, a print processor and/or other components for eventual arrival at a printing device. These embodiments further comprise an element that is capable of modifying a print job by adding or modifying printing device instructions within a print job file. These instruction modifications may be performed to enable printing device capabilities, in some cases where the printer driver is not able to access those capabilities.

In many embodiments, a user will initiate a print job, which may comprise multiple pages and/or multiple documents. Generally, a print job will be initiated through an application, but may also be initiated automatically or through a background process.

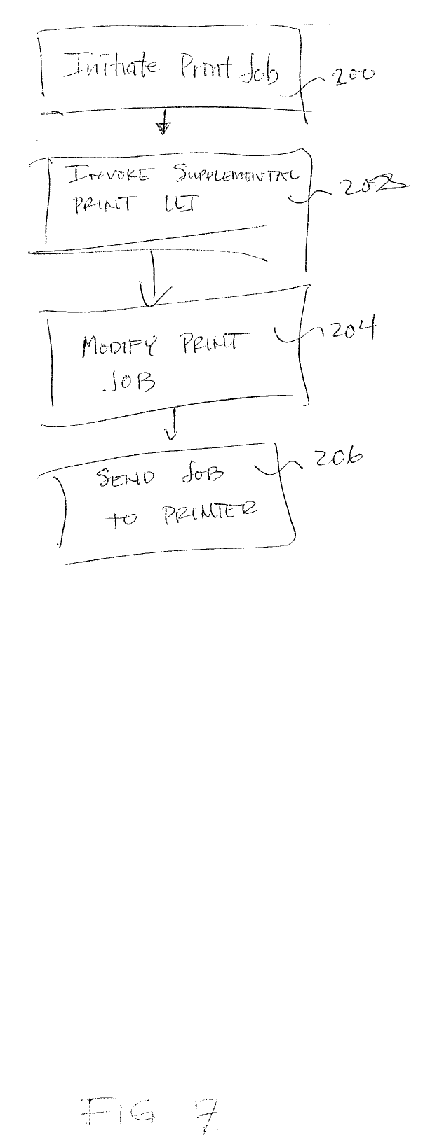

In some embodiments of the present invention, as illustrated in FIG. 7, a user initiates 200 a print job, generally through a menu selection, keyboard input or other command execution. Generally, this action would invoke a driver user interface, which would present a user with print options. However, when a printer driver has not been updated for a newer, more feature-rich printer, these print options will not fully access the new printer's capabilities.

In some embodiments of the present invention, this command to the printer driver is intercepted or otherwise re-directed to a supplemental printer user interface 202, which is independent of the printer driver. This supplemental print user interface 202, which can be designed to take full advantage of the newer printer's capabilities, may present a user with a complete set of advanced printer options. A user may then select 204 from the presented options those desired for the current print job. These embodiments of the present invention may then modify the print job by modifying, inserting and/or replacing job control commands, page control commands, page data or other print stream data. This print stream data may comprise an industry standard Page Description Language (PDL) such as Print Job Language (PJL), Printer Control Language (PCL) (i.e., PCL 5/XL), Postscript, Portable Document Format (PDF), journaled data, such as Enhanced MetaFile (EMF) or Proprietary MetaFile (PMF), another proprietary format or some other format.

Once the print job has been modified with the desired formatting or other modifications, the modified print job is sent to the printer 206 for conversion to hard copy output.

In some embodiments of the present invention, an application-based, driver-independent print modification method is used. In these embodiments, an application, from which a print command may be selected, is modified to allow selection of new printer features. This may be done through the addition of a user dialog or interface that present a user with newer printer options not available through the standard application and driver. In some of these embodiments, the options may be read from an external source, such as a disk file or registry. These options may be displayed dynamically to a user. An application does not need to “know” the function of the options and can, therefore, be modified once to accommodate unknown future options as they become available.

An exemplary file-based option input file may be structured as follows:

Begin Option

Title=N-Up Printing
Control=List Box
Type=String
Values=1up, 2up, 4up, 6up, 8up, 12 up, 16 up
Output=PJL NUP=$Input

End Option

An exemplary registry-based option input file may be structured as follows:

HLOCAL_USER_MACHINE\...\Custom Settings\NUP

.Title=N-Up Printing
.Control=List Box
.Type=String
.Values=1up, 2up, 4up, 6up, 8up, 12 up, 16 up
.Output=PJL NUP=$Input

In other embodiments of the present invention, options may be hard-coded, however this would necessitate application updates to accommodate newer options.

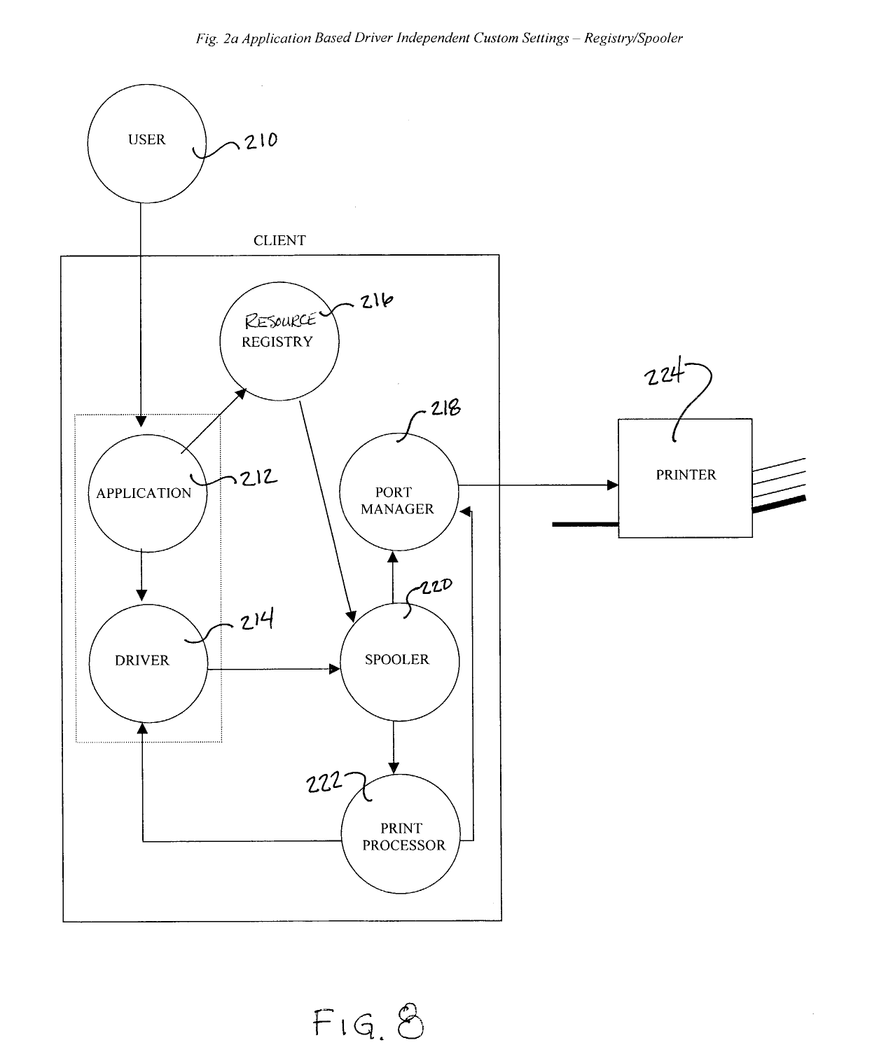

In some embodiments of the present invention, as illustrated in FIG. 8, a user 210 may make print option selections through an application 212, which has a printer user interface that provides for capabilities that are not enabled through the existing driver 214. These additional capability selections may be written to a resource 216 that is outside the normal print data stream. This resource 216 may be stored in a data file, an operating system registry or some other format and may reside in some type of memory or storage device such as RAM, hard disk or many other memory or storage formats. In some embodiments, resource 216 may be a spool directory file and may be identified with the same job ID as the print stream spool data or with some other resolvable file identifier that will serve to relate the resource-stored print options to the print stream data. In some embodiments, which employ a registry, the resource-stored data may be associated with the print stream data through a mirrored key that contains the same job ID.

Once the user selections have been made, the application 212 may invoke the internal or external printer driver 214. Driver 214 may work in conjunction with various other print stream components (i.e., GDI) and may utilize various intermediate files (i.e., job description file, EMF file, etc) that are not shown in FIG. 8 for clarity. Driver 214 then sends the print stream data to the spooler 220 for further processing. In some embodiments, a spooler 220 may access the resource 216 to obtain additional print option data that could not be enabled through driver 214.

This additional data may be used by spooler 220 to modify the print stream data and enable the additional print options. Spooler 220 may then forward the modified print stream data directly to a print processor 222 or to another print stream component 218 such as a port manager, port monitor or another component.

When a print system utilizes journaled files, such as EMF files, which are handled by the driver 214 multiple times, a print processor 222 may direct print stream data back to the driver 214, which may not be configured to recognize the modified print stream. In these embodiments, a spooler 220 or other print stream component may access a resource 216 and modify the print stream after the data has been processed by the driver 214 the last time. In the case of EMF data, the print stream data will be modified after it has been converted to raw data.

After the print stream data has been modified with the additional print option data, the modified print stream data may be sent to a port manager 218 such as a port monitor 76 in a Windows system or another component that will direct the print stream to the destination printer 224.

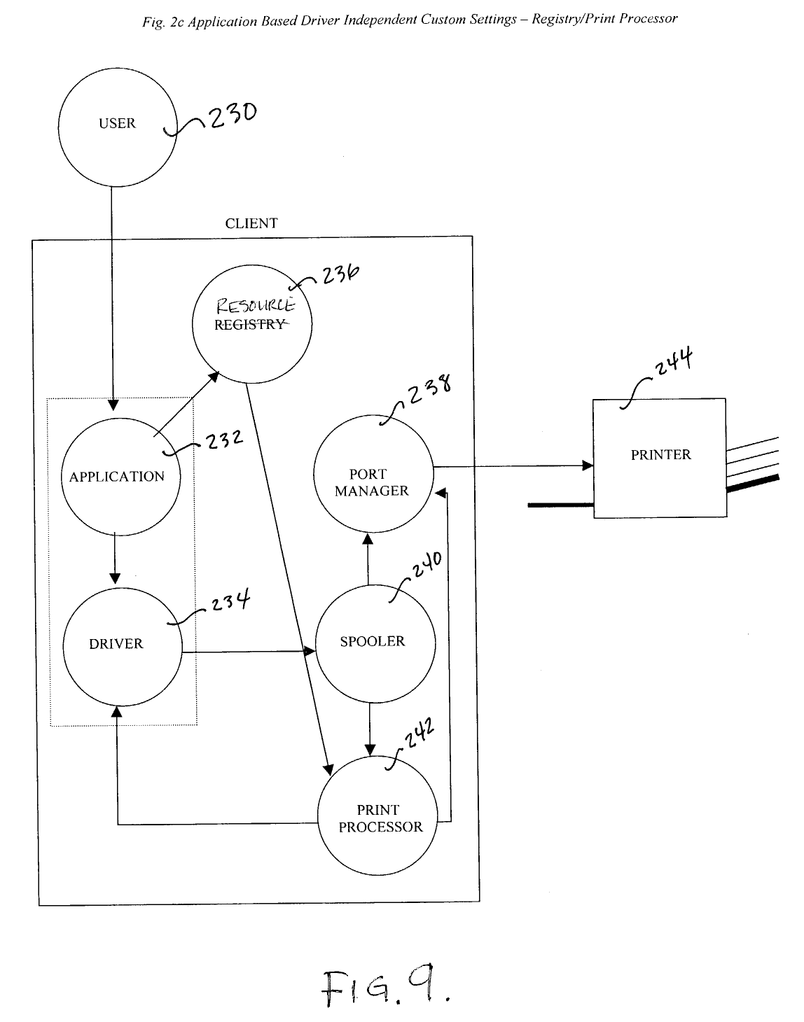

In other embodiments of the present invention, as shown in FIG. 9, a user 230 may make print option selections through an application 232, which has a printer user interface that provides for capabilities that are not enabled through the existing driver 214. These additional capability selections may be written to a resource 236 that is outside the normal print data stream as explained for other embodiments.

Once the user selections have been made, the application 232 may invoke the internal or external printer driver 234. Driver 234 may work in conjunction with various other print stream components (i.e., GDI) and may utilize various intermediate files (i.e., job description file, EMF file, etc) that are not shown in FIG. 9 for clarity. Driver 234 may then send the print stream data to the spooler 240. Spooler 240 may then send the print stream data on to a print processor 242.

When a print system utilizes journaled files, such as EMF files, a print processor 242 may direct print stream data back to the driver 234 for conversion to raw data. In these embodiments, a print processor 242 may direct print stream data back to the driver 234 where, with the aid of other print stream components, the data is converted to raw data and sent back to the spooler 240 and on to the print processor 242. When the application generates raw print data, this additional conversion loop is unnecessary and raw print data arriving at the print processor 242 will not be directed to the driver for additional processing.

Once the data has been fully processed by the driver 234 and sent back to the print processor 242, the print processor of embodiments of the present invention may access resource 236 to obtain additional print option data and modify the print stream data to include the additional print options. This modified data is then sent to a port manager 218 such as a port monitor 76 in a Windows system or another component that will direct the print stream to the destination printer 244.

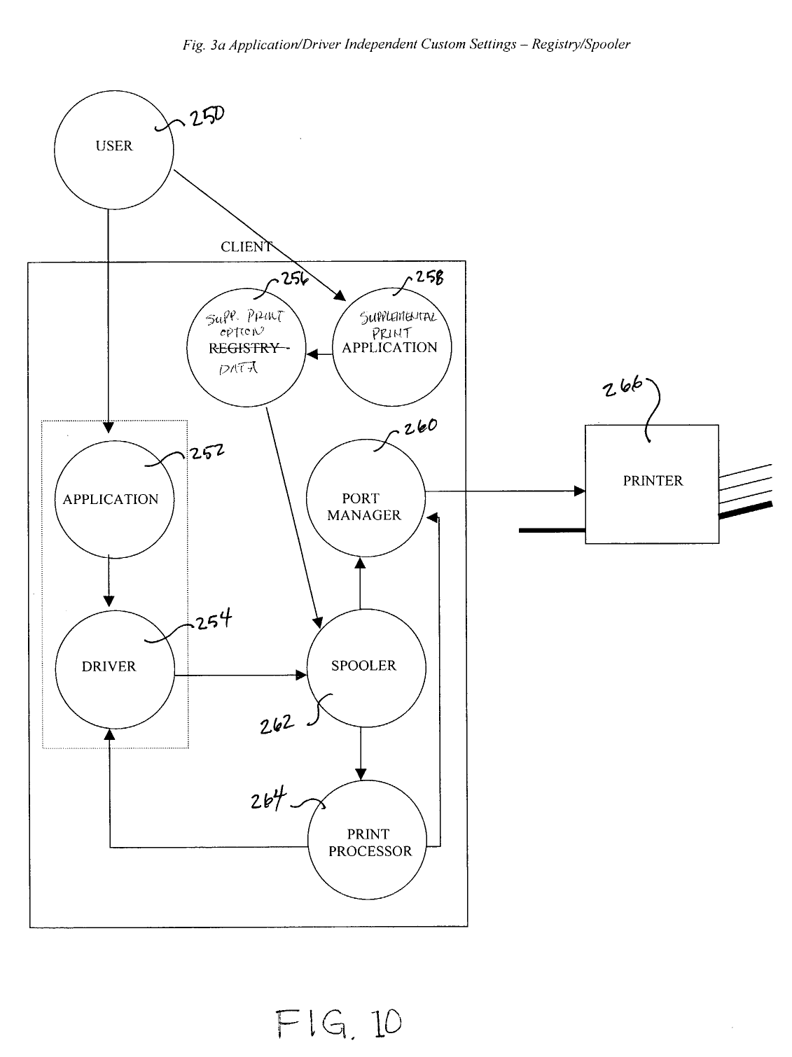

In more embodiments of the present invention, as illustrated in FIG. 10, a user 250 may create a document with a typical application 252 and select legacy print options therein. The print job will then be sent to a legacy driver 254 that may not have the ability to enable all the capabilities of a newer printer 266. In this case, a supplemental print application 258 may be accessed by a user to enable print options not available through the legacy driver 254. The supplemental print application 258 may prompt for and record user input relative to print options. This supplemental print option data 256 may be recorded in memory, a storage device or by some other means. Supplemental print option data 256 may also be stored in many formats including, but not limited to, a registry, a data file and others.

Supplemental print application 258 will generally be accessed and print option data 256 will generally be created prior to the selection of a print option in application 252 and activation of driver 254. In this manner, driver 254 may forward a print job to spooler 262 without interruption for user input.

When raw print data is generated on the initial pass through driver 254, print data is sent to spooler 262, which accesses supplemental print option data 256 and modifies the print data to enable supplemental print options not available through the legacy driver 254. This modified print data is then sent on through print processor 264 or directly to port manager 260. Port manager 260 then sends the modified print data to printer 266 for printing.

When journaled print data, such as EMF data, is produced by driver 254 and application 252, this journaled data is sent to spooler 262 and passed on to print processor 264 where it is redirected to driver 254 and associated components (i.e., GDI) for conversion to raw format. This raw format data is then sent to spooler 262 where it is modified with the supplemental print option data 256 and sent to through print stream components to printer 266 as explained for initial raw print data above.

In these supplemental print application embodiments, a user accesses a supplemental print application that prompts for options that are available on printer 266, but not available through a legacy driver 254. The supplemental print application 258 allows a user to select supplemental print options and create a supplemental print option record 256 that may be accessed by print stream components for modification of a print job.

A supplemental print application 258 may be accessed at any point prior to initiation of a print job. In other embodiments, a supplemental print application 258 may be invoked by print stream components (i.e., spooler 262, print processor 264, port manager 260 or other components) during the printing process. In these embodiments, a supplemental print application user interface may prompt a user for supplemental print option selection while the print job is progressing down the print stream through print stream components.

With reference to FIGS. 1-11, a supplemental print application 258 may be invoked by practically any print stream component illustrated in FIGS. 1-11 and described in reference thereto.

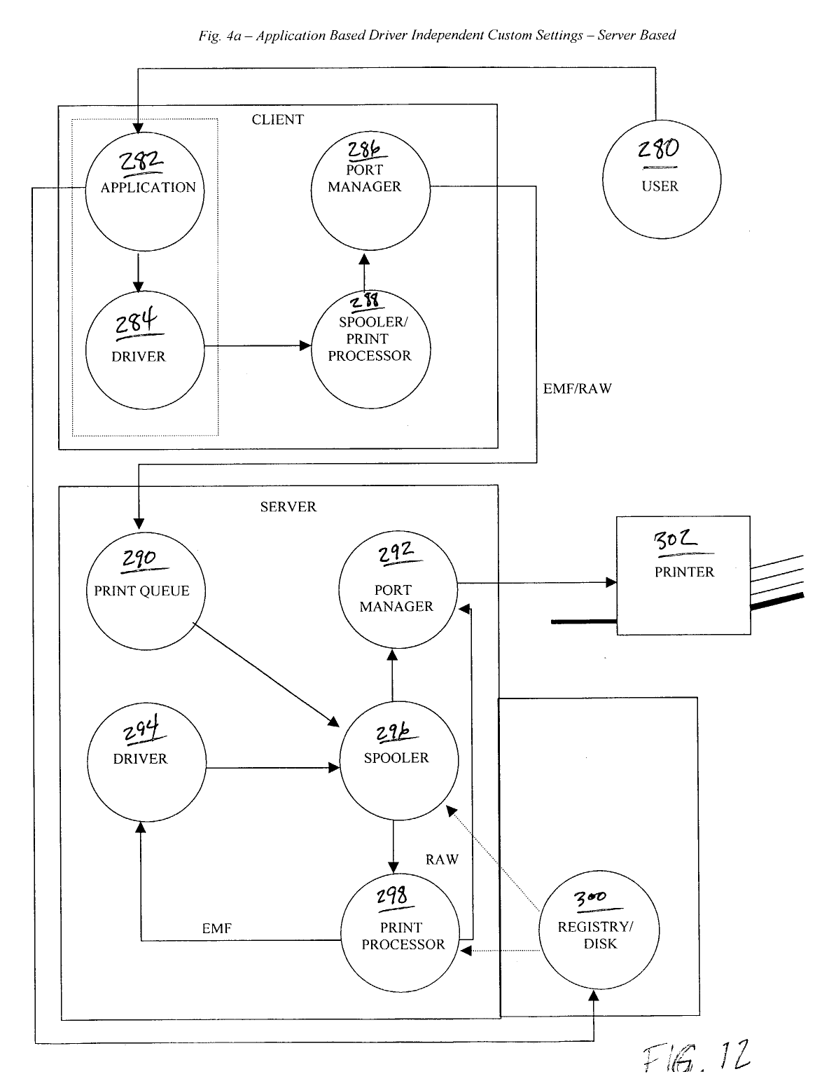

Other embodiments of the present invention may be implemented on networks with print servers. Some of these embodiments may be explained with reference to FIG. 12. In these embodiments, a user 280 initiates a print job with an application 282, which sends print data to driver 284, which may or may not be an integral part of application 282. Driver 284 may convert the print data to a printer-readable format, but may not take advantage of all the features and capabilities of advanced printer 302. Driver 284 sends the data to port manager 286, which may comprise a language monitor, port monitor and/or other print system components. Port manager 286 sends the print data on to network print queue 290 where it waits for spooler/printer availability.

When resources are available, spooler 296 receives the print data. In some embodiments spooler 296 may modify the print data to take advantage of newer printer options. This may be accomplished with supplemental print option data 300 stored in memory, on a disk, in a registry or in some other form. Supplemental print data may be created through the application 282 that has been modified to create this data. In other embodiments, spooler 296 will send the unmodified print data directly to print processor 298, which will access supplemental print data 300. Regardless of the print system component that accesses the supplemental print data, the print data will be modified to take advantage of printer capabilities not enabled by the driver 284. For raw format data or other printer-ready data, the modified print data may be sent to port manager 292 and on to printer 302. For journaled data, the print processor 298 will send the data back to the driver 294 for conversion to printer-ready data before modification with supplemental print option data. In these cases, the print processor 298 will send the modified data to the port manager 292 on the second pass through the print processor 298 after which the data will pass to printer 302.

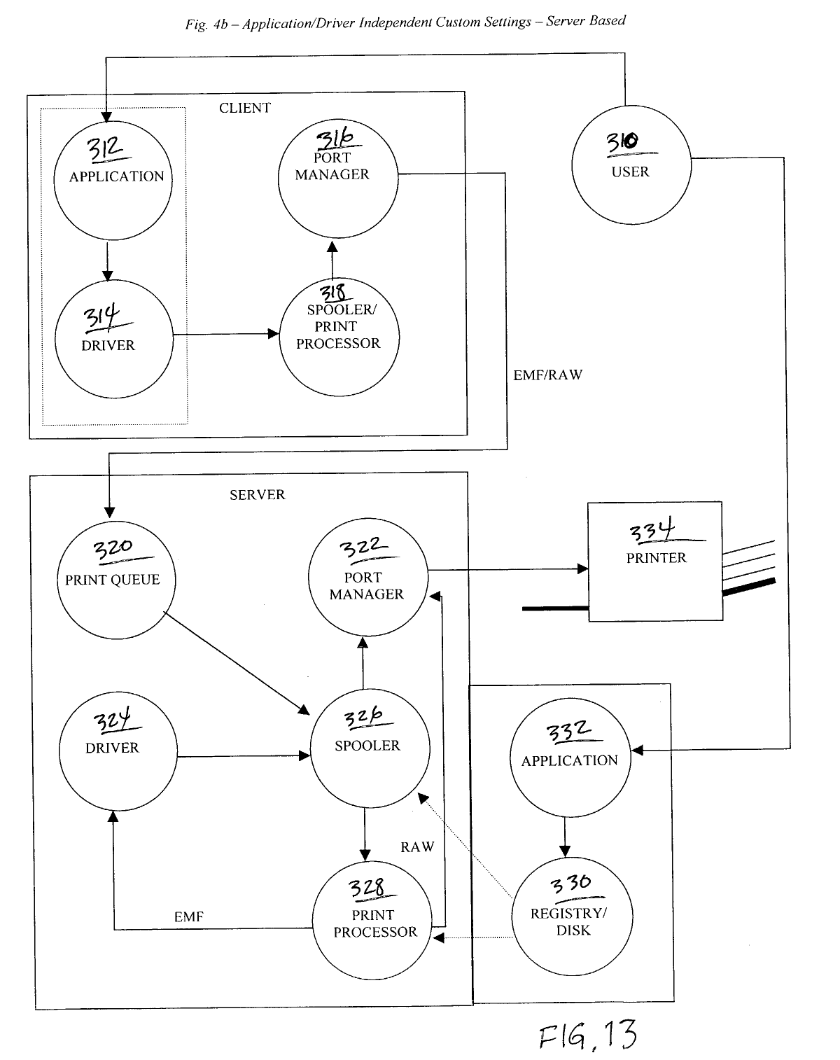

Similar server-based methods may be described with reference to FIG. 13. In these embodiments, a supplemental print configuration application 332 may be used to gather supplemental print option preferences from a user 310. In these embodiments, a user 310 may activate a supplemental print option application 332 to configure a print job using advanced printer features not accessible through legacy print driver 314. Supplemental print application 332 will store the user preferences as supplemental print option data 330 in a file, memory or other form. A user 310 may then utilize an application 312 and initiate a print job with the application 312.

When a print job is initialized, print data will be sent to driver 314, where the print data will be converted to a printer-readable format, when appropriate, and be sent on to the client spooler, print processor 318 and port manager 316, which will direct the data to the server print queue 320. The print data will then be forwarded to the spooler 326 and, when appropriate directed to a print processor 328 and back to a driver 324 before returning to the spooler 326. This printer-ready print data may then be modified to enable supplemental print options in the spooler 326, print processor 328 or another supplemental print option enabling print stream component. These enabling components may access supplemental print option data 330 that has been created by supplemental application 332 either prior to print job initiation or during processing of the print job.

Once modification of the print data has been accomplished, the modified data may be directed along the print stream through port manager 322 and on to the destination printer 334.

In some embodiments of the present invention, inventive function may be implemented in a custom print system component that is added to the print stream to accomplish its particular functions. In some embodiments, inventive functions may be performed through a port monitor.

The present invention may be embodied in other specific forms without departing from its spirit or essential characteristics. The described embodiments are to be considered in all respects only as illustrative and not restrictive. The scope of the invention is, therefore, indicated by the appended claims rather than by the foregoing description. All changes which come within the meaning and range of equivalency of the claims are to be embraced within their scope.

What is claimed is:

1. A method of enabling printer capabilities not supported by a legacy driver, said method comprising:
sending a print job to a legacy print driver that does not support all capabilities of a desired printer;
modifying said print job with a print system component to enable a printer capability not supported by said legacy driver; and
sending said print task to said desired printer for printing.

2. The method of claim 1 wherein said print system component is a spooler.

3. The method of claim 1 wherein said print system component is a print processor.

4. The method of claim 1 wherein said print system component is a port manager.

5. The method of claim 1 wherein said print system component is a custom print system component.

6. The method of claim 1 wherein said modifying comprises accessing supplemental print option data obtained through a user interface.

7. The method of claim 6 wherein said user interface is invoked from the application used to create the document to be printed.

8. The method of claim 6 wherein said user interface is invoked from a supplemental print application.

9. A method of enabling printer capabilities not supported by a legacy driver, said method comprising:
selecting print options in an application;
recording said print option selections;
sending a print job to a legacy print driver that does not support all capabilities of a desired printer;
modifying said print job with a print system component to enable a printer capability not supported by said legacy driver, said modifying based on said recorded print option selections.

10. The method of claim 9 wherein said print system component resides on a server.

11. The method of claim 9 wherein said application dedicated supplementary print option application.

12. A method for modifying a print job to enable capabilities not supported by a driver, said method comprising:
selecting print options in an application;
recording said print option selections;
sending a print job to a print driver that does not support all capabilities of a desired printer;
modifying said print job with a print system component to enable a printer capability not supported by said driver, said modifying based on said recorded print option selections; and
sending said print task to said desired printer for printing.
